(19) United States
(12) Patent Application Publication
(10) Pub. No.: US 2026/0199169 A1
(43) Pub. Date: Jul. 16, 2026

(54) ARTIFICIAL INTELLIGENCE BASED ADJUSTABLE SPINE AND EXTREMITY TRACTION DEVICE

(71) Applicants: Miles Fortner, Gillette, WY (US); Deed Harrison, Eagle, ID (US); Curtis Fedorchuck, Cumming, GA (US)

(72) Inventors: Miles Fortner, Gillette, WY (US); Deed Harrison, Eagle, ID (US); Curtis Fedorchuck, Cumming, GA (US)

(21) Appl. No.: 19/015,979

(22) Filed: Jan. 10, 2025

(51) Int. Cl. A61H 1/02

(52) U.S. Cl. CPC A61H 1/0222; A61H 2201/5071; A61H 2201/5092; A61H 2230/605

(57) ABSTRACT

A system may include at least one computing device in operable communication with a network; an application server in operable communication with the at least one computing device over the network, the application server configured to host an application program configured to: read at least one pressure of a joint complex via at least one pressure sensor; measure a distance of joint complex movement via at least one laser; and predict a specific load to the joint complex to alter the joint complex's shape and position via an artificial intelligence model based on radiographic parameters, the at least one pressure of the joint complex, and the distance of the joint complex movement.

### TECHNICAL FIELD

The embodiments generally relate to the technical field of traction devices.

### BACKGROUND

Conventional traction devices are medical tools designed to apply controlled force to gently stretch and align parts of the body, typically to relieve pain, reduce pressure on nerves, or correct deformities. Traction devices may be used for orthopedic conditions, such as spinal misalignment, herniated discs, or joint problems, as well as during rehabilitation after injuries. Traction devices create a pulling force that separates bones, joints, or soft tissues, which can help improve blood flow, relieve muscle spasms, and promote healing. For example, cervical traction devices are often used to alleviate neck pain by stretching the neck and reducing pressure on cervical vertebrae and nerves. Lumbar traction devices target the lower back in a similar manner. Patients may use these devices in clinical settings or at home, depending on the condition and treatment plan. Proper use involves securing the device around the affected area, adjusting the tension according to medical guidance, and maintaining the position for a specified duration. By using traction devices correctly, patients can experience relief and support for their recovery process. Traction devices incorporating computer technology may be preprogrammed for linear direction pull based on the weight of the patient or other factors manually input into the system.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

In one aspect, an artificial intelligence (AI) based adjustable spine and extremity traction device may include at least one pressure sensor configured to read at least one pressure of a spine; at least one laser configured to measure a distance of spinal movement; a module removably attached to a traction device; and wherein the module is configured to incorporate radiographic parameters into an artificial intelligence model to predict and accurately reproduce predicted specific load to the spine to alter the spine's shape and position based on the radiographic parameters, at least one pressure of the spine, and the distance of spinal movement.

In one aspect, variations of the disclosed traction device may be configured to perform a predictive method of stretching or tractioning a joint complex (the spine or an extremity) based on disc, ligament, or joint injuries while requiring less manual reproduction of the movement for the sake of consistent rehabilitation.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments;

FIG. 3 illustrates a traction table and an application program and modules in communication with the computing system, according to some embodiments;

FIG. 4 illustrates a traction table and an application program and modules in communication with the computing system, according to some embodiments; and

FIG. 5 illustrates a method of using a traction table and an application program and modules in communication with the computing system, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, “traction device” and variations of that term may refer to any device used to apply force to parts of the body in order to stretch or align portions of the body, including, but not limited to, tables, seated devices, universal traction systems, home-traction units, prone devices, supine devices, etc.

Conventional traction tables provide, most commonly, pull in a linear fashion but do not allow for bending of a joint complex, such as the spine, in all six degrees of freedom. That is, conventional traction tables cannot provide pull in three translational directions (e.g., along an X, Y, and Z axis) or three rotational motions (e.g., pitch, yaw, and roll). Additionally, traditional systems do not incorporate radiographic parameters read via device sensors into an AI model to predict and accurately reproduce predicted specific load to a joint complex to alter the joint complex's shape and position based on the radiographic parameters.

According to embodiments, the disclosed traction device addresses shortcomings in conventional traction tables by incorporating an AI model configured to receive radiographic data from on-board sensors, and determine, via the AI model, specific load to a joint complex to alter the joint complex's shape and position to alleviate stress, pain, or perform physical therapy.

In practice and in use, variations of the disclosed traction table may be utilized in cases where the conventional linear pull is insufficient to stretch or align portions of the body. Variations of the disclosed traction table reduce the need for accurate reproduction in the physical therapy arena. The disclosed traction table allows for home devices to be accurate and not patient-dependent. Patients will be able to have proper rehab at home with less chance of injury with no supervision of a health care provider. The disclosed traction table allows surgeons to replace spine deformities and injuries and hold the spine while a procedure is performed. The disclosed traction table may also be configured to build a database of reference data for healthcare providers with less clinical experience to be able to treat complex conditions better.

Implementations of the invention involve the technical field of tractions devices including computer-implemented AI models and are therefore necessarily rooted in computer technology. For example, the function of incorporating radiographic parameters into an artificial intelligence model to predict and accurately reproduce predicted specific load to the spine to alter the spine's shape and position based on the radiographic parameters, at least one pressure of the spine, and the distance of spinal movement are computer-based and cannot be performed in the human mind. Additionally, the steps of the present invention would be impossible to accomplish on pen and paper due to the volume of data being communicated and received over a network in real-time. In particular, the speed at which the steps of the present invention occur to effectuate the disclosed method, system, or product would involve large-scale, continuous communication of such data. That is, the steps of the present method, system, or product are impossible to accomplish on pen and paper, cannot be accomplished as a method of organizing human activity, and amount to significantly more than merely gathering, analyzing, and outputting data.

Implementations of the present invention include implementing (executing, running, or deploying) one or more artificial intelligence models on a computing device wherein the computing device executes the artificial intelligence model's algorithms and mathematical functions on computer hardware using machine learning libraries. The computing device implements the artificial intelligence model when it performs tasks like training, making predictions, applying the model to data, decision-making, classification, or generating outputs based on inputs. In particular, the speed at which an artificial intelligence model occur to analyzes and transforms data to effectuate the disclosed method, system, or product would involve large-scale, continuous transformation of such data. As such, the present invention would be impossible to accomplish on pen and paper or in the human mind due to the volume of data being analyzed and transformed by the artificial intelligence model.

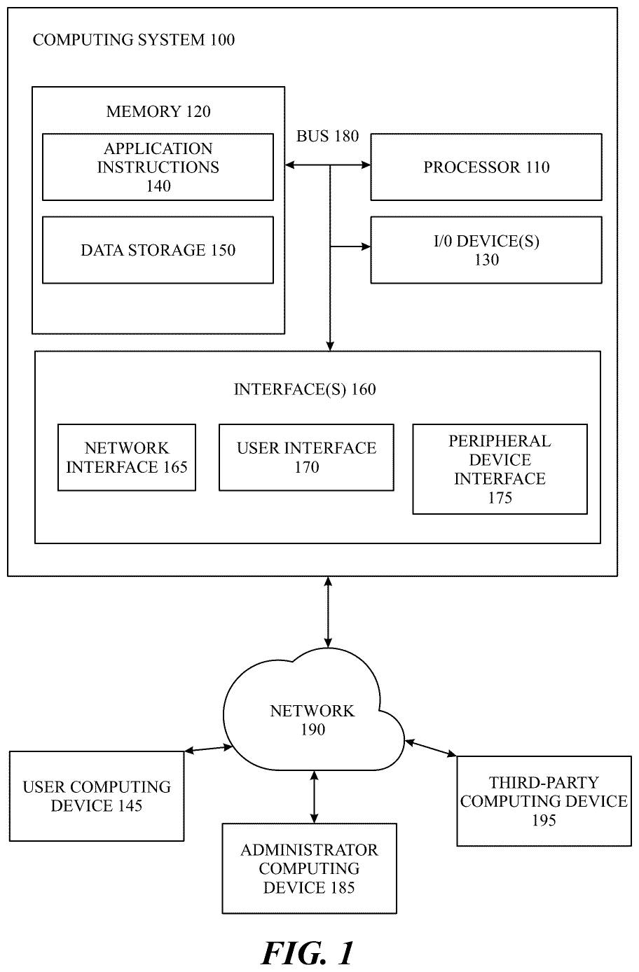

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computer system 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as pressure sensors, lasers, video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 140, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,“ “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized by a user to interact with the various functionalities of the system, including to review radiographic parameters, laser data, pressure sensor data, etc. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

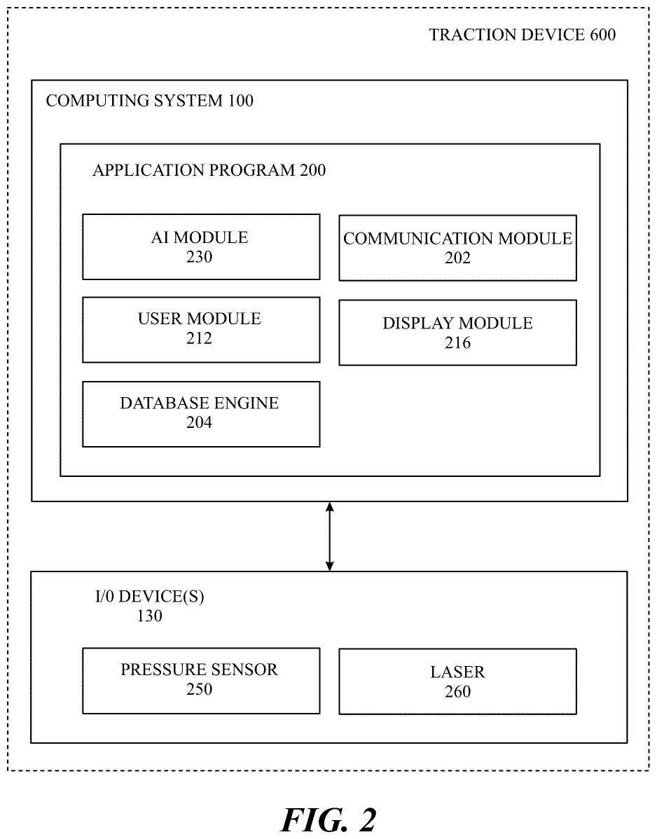

FIG. 2 illustrates an example of computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of an AI module 230, a communication module 202, a database engine 204, a user module 212, and a display module 216.

In some embodiments, the AI module 230 may be configured to predict a specific load to a joint complex to alter the spine's shape and position based on received radiographic parameters, a measured pressure of the joint complex, and the distance of joint complex movement. Joint complex pressure and movement may be measured and monitored, for example, via a sensor or laser, or via radiographic data. The AI module 230 may be configured to predict specific load to a joint complex to alter the spine's shape and position based on rule-based logic. The AI module 230 may be configured to read pressures on the spine and measure the distance that movements occur as well as incorporate radiographic parameters to move the table through all six freedoms of movements to predict the best pattern of movement to alter or change the shape of the patient's spine or joint complex. The AI module 230 may be, for example, a convolutional neural network configured for image classification, object detection, and image segmentation of radiographic data; a generative adversarial network or variational autoencoder used for image synthesis, enhancement, or identifying latent features in radiographic data; a recurrent neural network for sequence prediction within radio graphic data or a similar AI model. In this way, the AI module 230 is configured to predict a specific load to a joint complex based on radiographic parameters, the at least one pressure of the joint complex, and the distance of spinal movement by analyzing radiographic image data and predicting traction table movements to alter the joint complex's shape and position.

In some embodiments, the AI module 230 may be configured to instruct traction table actuators, e.g., motors, to alter the position or movement of the traction table in order to effectuate the predicted specific load to a joint complex to alter the spine's shape and position based on received radiographic parameters, a measured pressure of the joint complex, and the distance of joint complex movement.

In some embodiments, the communication module 202 is configured for receiving, processing, and transmitting a user command and/or one or more data streams. In such embodiments, the communication module 202 performs communication functions between various devices, including the user computing device 145 of FIG. 1, the administrator computing device 185 of FIG. 1, and a third-party computing device 195 of FIG. 1. In some embodiments, the communication module 202 is configured to facilitate operative connection between the disclosed system and a user device, such as a smart device, over wireless protocols such as Bluetooth. In some embodiments, the communication module 202 is configured to allow one or more users of the system, including a third-party, to communicate with one another. In some embodiments, the communications module 202 is configured to maintain one or more communication sessions with one or more servers, the administrative computing device 185 of FIG. 1, and/or one or more third-party computing device(s) 195 of FIG. 1. In some embodiments, the communication module 202 may allow users and administrators to communicate with one another.

In some embodiments, a database engine 204 is configured to facilitate the storage, management, and retrieval of data to and from one or more storage mediums, such as the one or more internal databases described herein. In some embodiments, the database engine 204 is a distributed ledger, i.e., a blockchain, configured to record and store radiographic parameters, traction device settings, etc. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

The user module 212 may store user preferences including the user account information, historical usage data, user personal information, and the like. The user module 212 may facilitate the creation of user's profiles for users, administrators, and others.

In some embodiments, the display module 216 is configured to display one or more graphic user interfaces, including, e.g., one or more user interfaces. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 displays information, notifications, and alerts to the user device which can be viewed and acknowledged by the user.

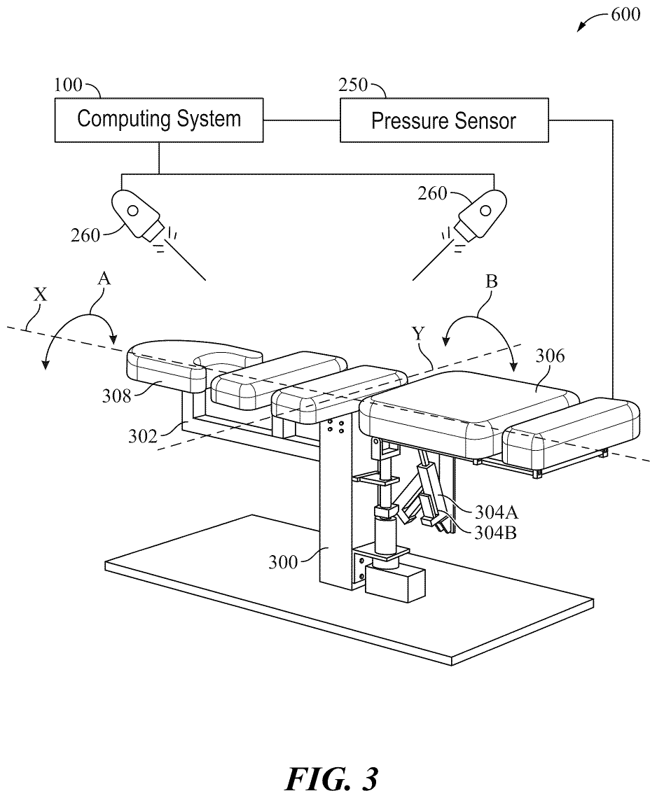

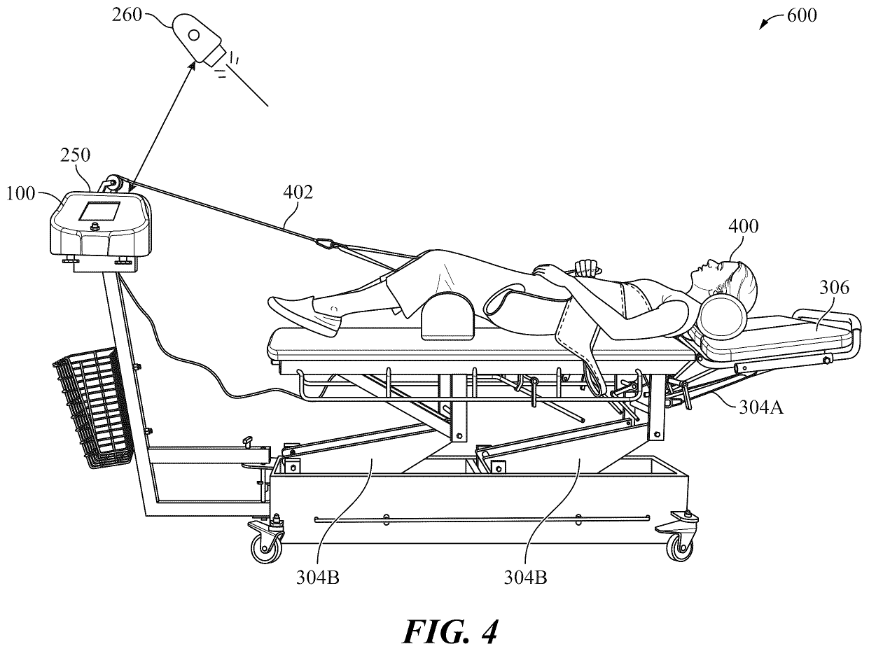

FIGS. 3 and 4 illustrate a traction device 600 including a traction table 306 and an application program 600 and modules in communication with the computing system 100, including at least one pressure sensor 250 configured to read at least one pressure of a spine and at least one laser 260 configured to measure a distance of spinal movement when a person 400 uses the traction table 206. The traction table 306 may include a frame 300 and a number of actuators 304A, 304B and alignment components 308, 402 constructed and arranged to facilitate spinal or joint alignment of the person 400 during use. The Traction table 206 may be configured to rotate, pivot, turn, or otherwise adjust or move about directions “A” and “B” or axis “X” and “Y” via the actuators 304A, 304B and alignment components 308, 402 to facilitate spinal or joint alignment of the person 400 during use.

As depicted in FIG. 4, the computing system 100 may include pressure sensors 250, which may be in operative communication with actuators 304A, 304B or alignment components 308, 402 for reading pressure, or may be in operative communication with the laser 260 configured to measure a distance of spinal movement when a person 400 uses the traction table 206. In embodiments, computing system 100 includes the AI module 230 of FIG. 2 for predicting and accurately reproducing predicted specific loads to the spine to alter the spine's shape and position based on the radiographic parameters, at least one pressure of the spine, and the distance of spinal movement based on data read by the pressure sensor 250 and the laser 260.

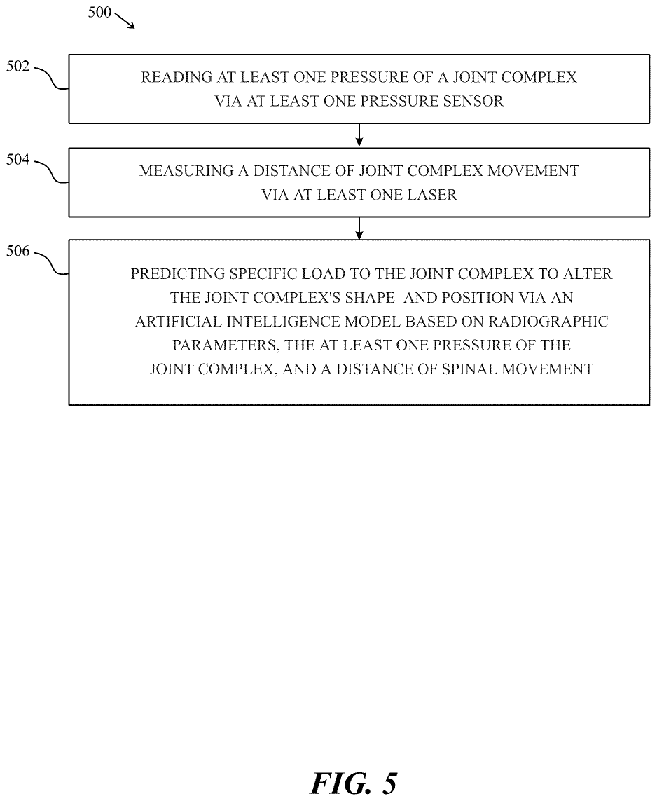

FIG. 5 illustrates a method 500 of using a traction device including a traction table and an application program and modules in communication with the computing system, according to some embodiments. According to step 502 the method may include reading at least one pressure of a joint complex via at least one pressure sensor via the traction device 600 of FIG. 2. In step 504, the method may include measuring a distance of joint complex movement via at least one laser via the traction device 600 of FIG. 2. In step 506, the method may include predicting specific load to the joint complex to alter the joint complex's shape and position via an artificial intelligence model based on radiographic parameters, the at least one pressure of the joint complex, and a distance of spinal movement via the AI module 230 of FIG. 2.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A system for artificial intelligence-based adjustable spine and extremity traction, the system comprising:
at least one pressure sensor configured to read at least one pressure of a spine;
at least one laser configured to measure a distance of spinal movement;
an artificial intelligence module removably attached to a traction device; and
wherein the artificial intelligence module is configured to incorporate radiographic parameters into an artificial intelligence model to predict and accurately reproduce predicted specific load to the spine to alter the spine's shape and position based on the radiographic parameters, at least one pressure of the spine, and the distance of spinal movement.

2. The system of claim 1, wherein the traction device is configured to reproduce movement patterns of a specific order based on the predicted specific load.

3. The system of claim 1, further comprising measuring muscle activation and pressure load via the at least one pressure sensor and the at least one laser.

4. The system of claim 1, further comprising adjusting a traction device movement based on a muscle activation and a pressure load.

5. The system of claim 4, wherein the adjusting comprises stopping the traction device movement.

6. The system of claim 1, wherein the artificial intelligence module is further configured to securely record predicted specific load to the spine to alter a spine's shape and position based on the radiographic parameters, at least one pressure of the spine, and the distance of spinal movement in a blockchain.

7. The system of claim 6, wherein the artificial intelligence model is configured to predict and accurately reproduce predicted specific load to the spine to alter the spine's shape and position based on a plurality of predicted specific loads recorded in the blockchain.

8. The system of claim 1, further comprising bending the spine through 6 degrees of freedom movement based on the radiographic parameters, at least one pressure of the spine, and the distance of spinal movement.

9. The system of claim 8, wherein the bending brings the spine to a neutral position and reduce pressure to at least one specific joint segments.

10. A method of artificial intelligence-based adjustable spine and extremity traction, the method comprising:
reading at least one pressure of a joint complex via at least one pressure sensor;
measuring a distance of joint complex movement via at least one laser; and
predicting specific load to the joint complex to alter the joint complex's shape and position via an artificial intelligence model based on radiographic parameters, the at least one pressure of the joint complex, and a distance of spinal movement.

11. The method of claim 10, further comprising measuring muscle activation and pressure load via the at least one pressure sensor and the at least one laser.

12. The method of claim 10, further comprising adjusting a traction device movement based on a muscle activation and a pressure load.

13. The method of claim 12, wherein the traction device is configured to reproduce movement patterns of a specific order based on the predicted specific load.

14. The method of claim 13, further comprising stopping the traction device movement.

15. The method of claim 10, further comprising bending the joint complex through 6 degrees of freedom movement based on the radiographic parameters, at least one pressure of the joint complex, and a distance of spinal movement.

16. The method of claim 15, wherein the bending brings the joint complex to a neutral position and reduce pressure to at least one specific joint complex segments.

17. The method of claim 10, further comprising securely recording predicted specific load to the joint complex to alter the joint complex's shape and position based on the radiographic parameters, at least one pressure of the joint complex, and the distance of spinal movement in a blockchain.

18. The method of claim 17, wherein the artificial intelligence model is configured to predict and accurately reproduce predicted specific load to the joint complex to alter the joint complex's shape and position based on a plurality of predicted specific loads recorded in the blockchain.

19. A system comprising:
at least one computing device in operable communication with a network;
an application server in operable communication with the at least one computing device over the network, the application server configured to host an application program configured to:
read at least one pressure of a joint complex via at least one pressure sensor;
measure a distance of joint complex movement via at least one laser; and
predict a specific load to a joint complex to alter the joint complex's shape and position via an artificial intelligence model based on radiographic parameters, the at least one pressure of the joint complex, and the distance of joint complex movement.

20. The system of claim 19, wherein the artificial intelligence model is configured to predict traction device movements to alter the joint complex's shape and position.
